(19) United States
(12) Patent Application Publication
(10) Pub. No.: US 2013/0229075 A1
(43) Pub. Date: Sep. 5, 2013

(54) MOTOR HAVING A SEAL ASSEMBLY

(71) Applicants: Ravi Kumar Musinana, Hyderabad (IN); Sandro Oliveira, Sao Paulo (BR); Danilo Sartoram, Campinas (BR); Jose Luiz Moraes, Campinas (BR)

(72) Inventors: Ravi Kumar Musinana, Hyderabad (IN); Sandro Oliveira, Sao Paulo (BR); Danilo Sartoram, Campinas (BR); Jose Luiz Moraes, Campinas (BR)

(73) Assignee: GENERAL ELECTRIC COMPANY, Schenectady, NY (US)

(21) Appl. No.: 13/409,471

(22) Filed: Mar. 1, 2012

(51) Int. Cl. H02K 5/10

(52) U.S. Cl. 310/88

(57) ABSTRACT

A motor having a seal assembly includes a motor housing having a rotatable shaft disposed therein. Also included is a first seal operably coupled to the rotatable shaft and having an engagement portion, wherein the first seal is configured to rotate in conjunction with the rotatable shaft. Further included is a second seal disposed in the motor housing and having a guiding portion, wherein the engagement portion of the first seal guidably rotates within the guiding portion of the second seal forming at least one labyrinth seal, and wherein at least one of the first seal and the second seal comprise an insulated material.

### BACKGROUND OF THE INVENTION

The subject matter disclosed herein relates to motors, and more particularly to seal assemblies therein.

Seal assemblies associated with motors are typically employed for a high degree of ingress protection of motor components, such as bearings, from dust and water, for example. One such seal assembly is a labyrinth seal assembly and often includes two components, a rotating portion and a static, or stationary, portion, both of which are typically made of a metal, such as steel or bronze. The rotating part may be fit on a shaft and engaged with the static portion. In particular applications, such as variable frequency drive (VFD) applications, the motor is subjected to shaft currents. The shaft currents result in undesirable effects associated with the bearings, seals, and potentially other motor components. In the case of labyrinth seals, the rotating part rotates relative to the static part in operation. In a case where these parts are made of steel, there is a relatively small gap between the parts. In some cases, metal to metal contact between the static and rotating parts may occur, with shaft currents due to the VFD drives causing undesirable effects.

### BRIEF DESCRIPTION OF THE INVENTION

According to one aspect of the invention, a motor having a seal assembly includes a motor housing having a rotatable shaft disposed therein. Also included is a first seal operably coupled to the rotatable shaft and having an engagement portion, wherein the first seal is configured to rotate in conjunction with the rotatable shaft. Further included is a second seal disposed in the motor housing and having a guiding portion, wherein the engagement portion of the first seal guidably rotates within the guiding portion of the second seal forming at least one labyrinth seal, and wherein at least one of the first seal and the second seal is includes an insulated material.

According to another aspect of the invention, a motor having a seal assembly includes a rotatable shaft. Also included is a first seal operably coupled to the rotatable shaft and having an engagement portion. Further included is a second seal having a guiding portion, wherein the engagement portion of the first seal guidably rotates within the guiding portion of the second seal, and wherein at least one of the first seal and the second seal is insulated with an insulating substance.

According to yet another aspect of the invention, a motor having a seal assembly includes a motor housing having a rotatable shaft disposed therein. Also included is a first seal operably coupled to the rotatable shaft and having an engagement portion, wherein the first seal is configured to rotate in conjunction with the rotatable shaft. Further included is a second seal that is relatively static and in operable connection with an end shield, wherein the second seal includes a guiding portion, wherein the engagement portion of the first seal guidably rotates within the guiding portion of the second seal, and wherein the second seal is insulated with an insulating substance.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a top, cross-sectional view of a motor having a drive end side and an opposite drive end side;

FIG. 2 is a perspective view of at least one seal assembly located proximate the drive end side of the motor; and

FIG. 3 is a perspective view of at least one seal assembly located proximate the opposite drive end side of the motor.

The detailed description explains embodiments of the invention, together with advantages and features, by way of example with reference to the drawings.

### DETAILED DESCRIPTION OF THE INVENTION

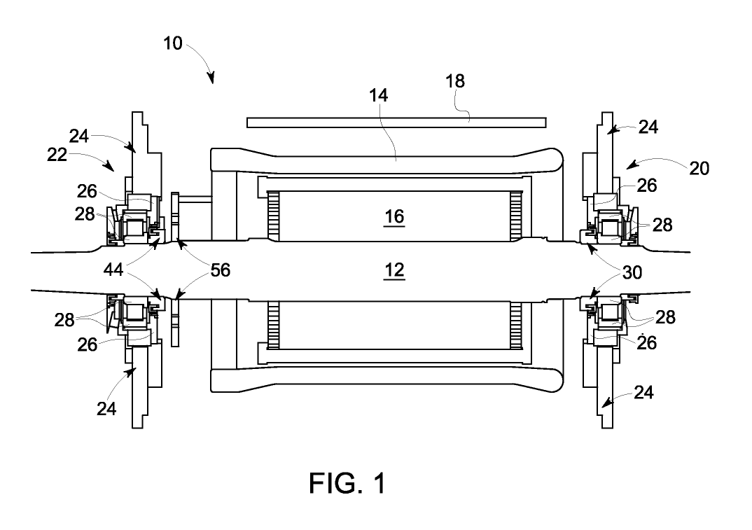

Referring to FIG. 1, an induction motor is generally referred to with the numeral 10. The induction motor 10 employed for the invention may be a single-phase or polyphase induction motor, and furthermore may be used in constant-speed applications or variable frequency drive (VFD) applications. More specifically, the induction motor 10 may be used in mining applications, for example.

The induction motor 10 includes power being supplied to a rotor, or a shaft 12, by means of electromagnetic induction via a stator core assembly 14. The shaft 12 extends within a rotor core assembly 16 and longitudinally from proximate a drive end (DE) side 20 of the induction motor 10 to an opposite drive end (ODE) side 22 of the induction motor. The induction motor 10 includes a motor housing 18 that operably supports and/or houses various components. Both the DE side 20 and the ODE side 22 include a number of similar components, such as an end shield 24, a bearing cap 26 and at least one bearing 28. Also included at both the DE side 20 and the ODE side 22 is at least one seal assembly for providing ingress protection of components of the induction motor 10, such as the at least one bearing 28. The ingress protection relates to the prevention of debris and particulate matter, such as dust, water, etc., from entering certain portions of the induction motor 10.

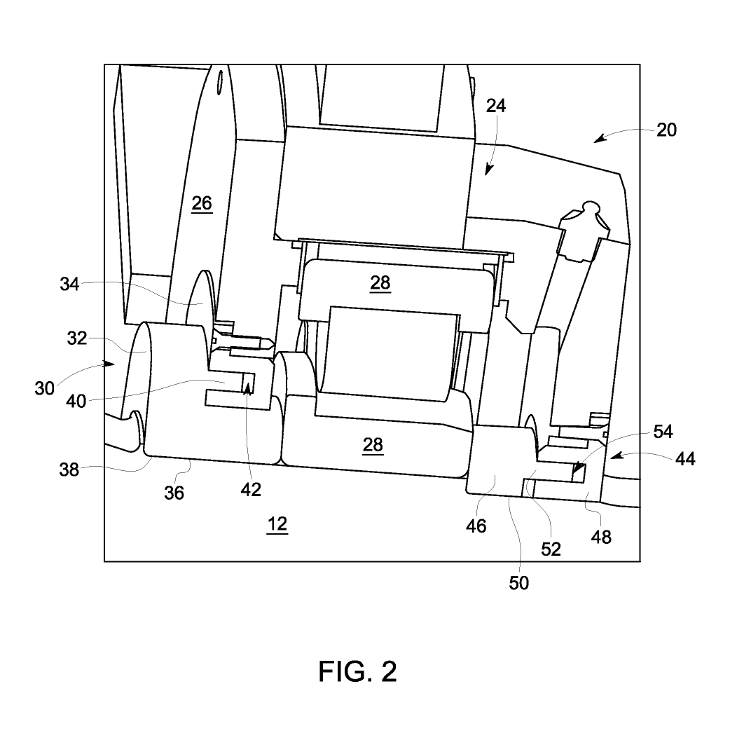

Referring now to FIG. 2, an enlarged, cross-sectional view of the DE side 20 of the induction motor 10 is illustrated. Included is an inner seal assembly 30 that is in operable connection with one or more components of the DE side 20, such as the bearing cap 26, for example. The inner seal assembly 30 includes a first seal component 32 and a second seal component 34. The first seal component 32 is rotatable and configured to be fit on the shaft 12 along a shaft outer diameter 36 and a first seal inner diameter 38. The first seal component 32 rotates with the shaft 12 and is disposed in close proximity, or in contact with, the at least one bearing 28. The first seal component 32 includes an engagement portion 40 that is of the form of a protrusion extending in an axial direction of the shaft 12 and circumferentially around the shaft 12. The first seal component 32 may be formed of numerous materials and will vary depending on the particular application of use. Common materials for the first seal component 32 include various metals including, but not limited to, steel and bronze.

The second seal component 34 of the inner seal assembly 30 is relatively static, or stationary, with respect to the first seal component 32, and includes a guiding portion 42 that is configured to fittingly receive the engagement portion 40 of the first seal component 32. In the illustrated embodiment, the guiding portion 42 is a recess that receives the engagement portion 40, but it is to be appreciated that numerous other geometric configurations may be employed to achieve a basic labyrinth function. The second seal component 34 may be formed of various insulating materials, with one such insulating material being epoxy glass cloth laminated sheet, for example. It is to be appreciated that various alternative insulating materials may be employed, provided the insulating material sufficiently insulates the seals from each other and from shaft currents that are commonly generated from the shaft 12 in VFD applications.

The DE side 20 of the induction motor 10 also includes an outer seal assembly 44 that is in operable connection with one or more components of the DE side 20, such as the shaft 12 and the end shield 24, for example. The outer seal assembly 44 includes a third seal component 46 and a fourth seal component 48. The third seal component 46 is rotatable and configured to be fit on the shaft 12 along the shaft outer diameter 36 and a third seal inner diameter 50. The third seal component 46 rotates with the shaft 12 at a rotational velocity equal to or less than that of the rotational velocity of the shaft 12 and is disposed in close proximity, or in contact with, the at least one bearing 28. The third seal component 46 includes an engagement portion 52 similar to that of the engagement portion 40 of the first seal component 32. Similar to the first seal component 32, the third seal component 46 may be formed of numerous materials and will vary depending on the particular application of use. Common materials for the third seal component 46 include various metals including, but not limited to, steel and bronze.

The fourth seal component 48 of the outer seal assembly 44 is relatively static, or stationary, with respect to the third seal component 46, and includes a guiding portion 54 similar to that of the guiding portion 42 of the second seal component 34. The fourth seal component 48 may be formed of various insulating materials, with one such insulating material being epoxy glass cloth laminated sheet, for example. It is to be appreciated that various alternative insulating materials may be employed, provided the insulating material sufficiently insulates the seals from shaft currents that are commonly generated from the shaft 12 in VFD applications.

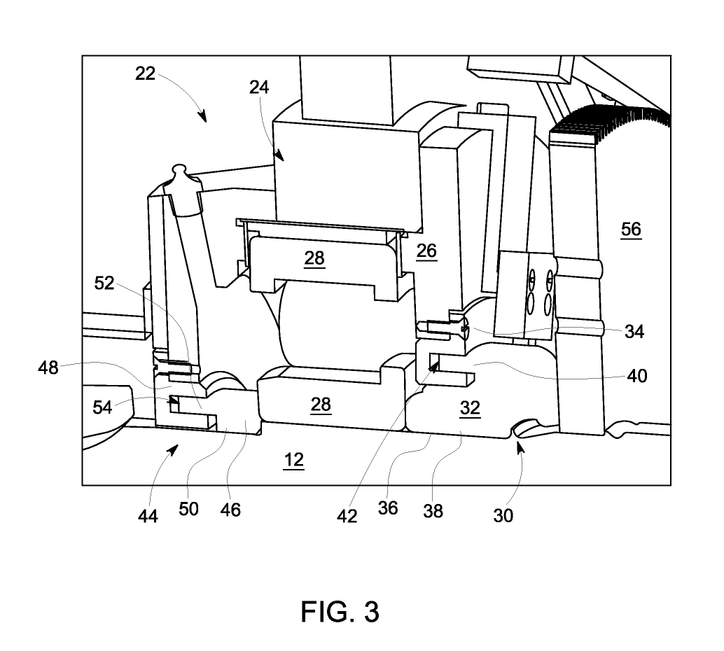

Referring now to FIG. 3, an enlarged, cross-sectional view of the ODE side 22 of the induction motor 10 is illustrated. As apparent from reference to the DE side 20 (FIG. 2), the ODE side 22 comprises similar components as that of the previously described DE side 20, yet simply arranged in a mirrored configuration. For simplicity of discussion, similar components will be referred to with common terminology and reference numerals. Included at the ODE side 22 is a ground brush 56, but it is to be appreciated that the induction motor 10 may be of a brushless variety. The ODE side 22 includes the inner seal assembly 30 and the outer seal assembly 44 that are similar in construction and arrangement as that of the DE side 20.

The foregoing description refers to the second seal component 34 and the fourth seal component 48 as being made of an insulated material, such as epoxy glass cloth laminated sheet, but it is to be understood that the first seal component 32 or the third seal component 46 may be formed of the insulated material. This may be independent of, or in combination with, the second seal component 34 and fourth seal component 48.

Alternatively, rather than at least one of the seal components 32, 34, 46 or 48 being made of an insulating material, the inner seal assembly 30 and/or the outer seal assembly 44 may be merely insulated. Various embodiments include sealing at least one of the seal components 32, 34, 46 or 48 with an insulating substance, such as a resin or a coating. Additionally, an insulating paper may be disposed proximate at least one of the seal components 32 or 46 with the shaft 28, or with seal components 34 or 48 with the enclosure.

Advantageously, the inner seal assembly 30 and/or the outer seal assembly 44 provide a high degree of ingress protection from debris and undesirable substances, as well as a resistance against shaft currents that may otherwise pass to components of the induction motor 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A motor having a seal assembly comprising:
a motor housing having a rotatable shaft disposed therein;
a first seal operably coupled to the rotatable shaft and having an engagement portion, wherein the first seal is configured to rotate in conjunction with the rotatable shaft;
a second seal disposed in the motor housing and having a guiding portion, wherein the engagement portion of the first seal guidably rotates within the guiding portion of the second seal forming at least one labyrinth seal; and
wherein at least one of the first seal and the second seal comprises an insulated material.

2. The motor of claim 1, wherein the insulated material is epoxy glass cloth laminated sheet.

3. The motor of claim 1, wherein the first seal and the second seal form an inner seal assembly.

4. The motor of claim 3, further comprising an outer seal assembly comprising:
a first outer seal operably coupled to the rotatable shaft, wherein the first outer seal is configured to rotate in conjunction with the rotatable shaft; and
a second outer seal disposed in the motor housing.

5. The motor of claim 1, wherein the guiding portion of the second seal is a recess that fittingly receives the engagement portion of the first seal.

6. The motor of claim 3, wherein the second seal comprises the insulated material.

7. The motor of claim 6, wherein the first seal comprises steel.

8. The motor of claim 6, wherein the first seal comprises bronze.

9. A motor having a seal assembly comprising:
a rotatable shaft;
a first seal operably coupled to the rotatable shaft and having an engagement portion;
a second seal having a guiding portion, wherein the engagement portion of the first seal guidably rotates within the guiding portion of the second seal; and
wherein at least one of the first seal and the second seal is insulated with an insulating substance.

10. The motor of claim 11, wherein the second seal is stationary relative to the first seal.

11. The motor of claim 9, wherein the first seal and the second seal form an inner seal assembly.

12. The motor of claim 11, further comprising an outer seal assembly comprising:
a first outer seal operably coupled to the rotatable shaft, wherein the first outer seal is configured to rotate in conjunction with the rotatable shaft; and
a second outer seal.

13. The motor of claim 9, wherein the guiding portion of the second seal is a recess that fittingly receives the engagement portion of the first seal.

14. The motor of claim 10, wherein the second seal is insulated with the insulating substance.

15. The motor of claim 14, wherein the insulating substance is an insulating resin.

16. The motor of claim 14, wherein the insulating substance is an insulating coating.

17. The motor of claim 14, wherein the first seal and the second seal comprise steel.

18. The motor of claim 10, wherein an insulating paper is disposed between the second seal and an end shield and also between the rotatable shaft and the first seal.

19. A motor having a seal assembly comprising:
a motor housing having a rotatable shaft disposed therein;
a first seal operably coupled to the rotatable shaft and having an engagement portion, wherein the first seal is configured to rotate in conjunction with the rotatable shaft;
a second seal that is relatively static and in operable connection with an end shield, wherein the second seal includes a guiding portion, wherein the engagement portion of the first seal guidably rotates within the guiding portion of the second seal; and
wherein the second seal is insulated with an insulating substance.
